(19) United States
(12) Patent Application Publication
(10) Pub. No.: US 2017/0204786 A1
(43) Pub. Date: Jul. 20, 2017

(54) SYSTEM AND METHOD FOR INJECTING TEMPERING AIR FOR HOT SCR CATALYST

(71) Applicant: General Electric Company, Schenectady, NY (US)

(72) Inventors: Hua Zhang, Greenville, SC (US); Parag Prakash Kulkarni, Schenectady, NY (US); Bradly Aaron Kippel, Greenville, SC (US)

(21) Appl. No.: 14/997,319

(22) Filed: Jan. 15, 2016

(51) Int. Cl. F02C 7/18; F02C 7/052

(52) U.S. Cl. CPC F02C 7/18; F02C 7/052

(57) ABSTRACT

A gas turbine system includes a gas turbine engine, an exhaust processing system disposed downstream of and fluidly coupled to the gas turbine engine, and an air delivery system that may supply treated air to the gas turbine engine and the exhaust processing system. The air delivery system includes a main air duct fluidly coupled to the gas turbine engine and that may supply a first portion of the treated air to the gas turbine engine, an auxiliary air duct fluidly coupled to the main air duct and the exhaust processing system and that may supply a second portion of the treated air to the exhaust processing system, and an air treatment unit fluidly coupled to the main air duct and that may generate the treated air.

### BACKGROUND OF THE INVENTION

The subject matter disclosed herein relates to turbine systems and, more specifically, to distribution of air to various components of the turbine system.

Gas turbine systems typically include at least one gas turbine engine having a compressor, a combustor, and a turbine. The combustor is configured to combust a mixture of fuel and compressed air to generate hot combustion gases, which, in turn, drive blades of the turbine. Exhaust gas produced by the gas turbine engine may include certain byproducts, such as nitrogen oxides (NOₓ), sulfur oxides (SOₓ), carbon oxides (COₓ), and unburned hydrocarbons.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a gas turbine system includes a gas turbine engine, an exhaust processing system disposed downstream of and fluidly coupled to the gas turbine engine, and an air delivery system that may supply treated air to the gas turbine engine and the exhaust processing system. The air delivery system includes a main air duct fluidly coupled to the gas turbine engine and that may supply a first portion of the treated air to the gas turbine engine, an auxiliary air duct fluidly coupled to the main air duct and the exhaust processing system and that may supply a second portion of the treated air to the exhaust processing system, and an air treatment unit fluidly coupled to the main air duct and that may generate the treated air.

In a second embodiment, a gas turbine system includes an air delivery system including an air treatment unit that may treat an air stream to generate treated air, a main air duct extending between the air treatment unit and a gas turbine engine and that may receive the treated air from the air treatment unit and to supply a first portion of the treated air to the gas turbine engine, and an auxiliary air duct fluidly coupled to the main air duct and that may receive a second portion of the treated air from the main air duct and to supply the second portion of the treated air to an exhaust processing system disposed downstream of the gas turbine engine and a control system having memory circuitry storing one or more sets of instructions executable by one or more processors of the control system to control an amount of the second portion of the treated air through the auxiliary duct based on a monitored parameter of an exhaust gas in the exhaust processing system.

In a third embodiment, a method includes flowing an air stream through an air delivery system of a gas turbine system. At least a portion of the air delivery system is disposed within an intake section of a gas turbine engine and includes a main air duct, an auxiliary air duct extending from the main air duct, and an air treatment unit disposed upstream of the main air duct. The method also includes filtering the air stream in the air treatment unit to generate treated air, supplying a first portion of the treated air to a compressor of a gas turbine engine of the gas turbine system via the main air duct, and supplying a second portion of the treated air from the main air duct to the auxiliary air duct. The auxiliary air duct is fluidly coupled to an exhaust processing system of the gas turbine system disposed downstream of the gas turbine engine.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of a gas turbine system including an air duct fluidly coupling an intake section of the gas turbine system with a transition section of an exhaust processing system, in accordance with an embodiment of the present disclosure;

FIG. 2 is a block diagram of a gas turbine system including an air duct fluidly coupling an intake section of the gas turbine system with an exhaust diffuser of an exhaust processing system, in accordance with an embodiment of the present disclosure;

FIG. 3 is a flow diagram of a method of cooling exhaust gases in the exhaust processing system using the air from the intake section of the gas turbine system, in accordance with an embodiment of the present disclosure; and

FIG. 4 is a flow diagram of a method of adjusting an amount of cooling air supplied to the exhaust processing system from the intake section of the gas turbine system based on a temperature of a cooled exhaust gas within the exhaust processing system, in accordance with an embodiment of the present disclosure.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

Embodiments disclosed herein generally relate to techniques for distributing treated air from a main air duct of a gas turbine system to multiple sections of the gas turbine system. For instance, in gas turbine systems, one or more gas turbine engines may combust a mixture of fuel and air to produce combustion gases for driving one or more turbines. Depending on the type of fuel that is combusted, emissions (e.g., exhaust gases) resulting from the combustion process may include nitrogen oxides (NOₓ), sulfur oxides (SOₓ), carbon oxides (COₓ), and unburned hydrocarbons. It may be desirable to reduce a level of these components before the exhaust gases exit the gas turbine system, such as a gas turbine power generation plant, while also maintaining efficient operation of the gas turbine system.

One technique for removing or reducing the amount of NOₓ in an exhaust gas stream is by Selective Catalytic Reduction (SCR). In an SCR process, a reagent, such as ammonia (NH₃) is injected into the exhaust gas stream and reacts with the NOₓ in the exhaust gas in the presence of a catalyst to produce nitrogen (N₂) and water (H₂O). The effectiveness of the SCR process may be at least partially dependent upon the temperature of the exhaust gas that is processed, which may be dependent on the particular catalyst used by the SCR system. By way of non-limiting example, the SCR process for removing NO may be particularly effective at temperatures of approximately 500 to 900 degrees Fahrenheit (° F.) (e.g., approximately 260 to 482 degrees Celsius (° C.)). Thus, where the exhaust gas output from the gas turbine engine is higher than the effective temperature range for SCR, it may be beneficial to cool the exhaust gases prior to SCR to increase the effectiveness of the SCR process (e.g., removal of NOₓ). The exhaust gas may be cooled using a stream of air.

Gas turbine systems may be configured to use ambient air to generate the combustion products and to cool the exhaust gases. However, ambient air may include contaminants that may need to be removed before use of the ambient air in the gas turbine system. For example, ambient air may include particulates and/or debris that may affect combustion and degrade system components (e.g., block air flow lines, wear system surfaces). Accordingly, the ambient air may be treated in an air treatment unit of the gas turbine system to remove the contaminants before use. Certain gas turbine systems include multiple air treatments systems distributed throughout various sections of the gas turbine system. For example, gas turbine systems may include air treatment units dedicated to each air duct (e.g., intake air duct, cooling air duct, evaporator air duct) and/or section of the gas turbine system. Having air treatment units dedicated to each air duct and/or section of the gas turbine system may result in complex system configurations, which may increase the overall operational and maintenance costs of the gas turbine system. Therefore, it may be desirable to reduce an amount of air treatment units within the gas turbine system to simplify the configuration and decrease the overall operational and maintenance costs of the gas turbine system.

In accordance with embodiments of the present disclosure, a gas turbine system, such as a simple cycle heavy-duty gas turbine system, may include an air delivery system that includes an air treatment unit configured to distribute treated air to multiple sections of the gas turbine system. By having the air delivery system distribute the treated air to multiple sections of the gas turbine system, the amount of air treatment units used to treat the air may be decreased, thereby simplifying the configuration of the gas turbine system. Further, while the presently disclosed techniques may be particularly useful in simple cycle heavy-duty gas turbine systems, as will be discussed below, it should be understood that the present technique may be implemented in any suitably configured system, including combined cycle gas turbine systems, for example.

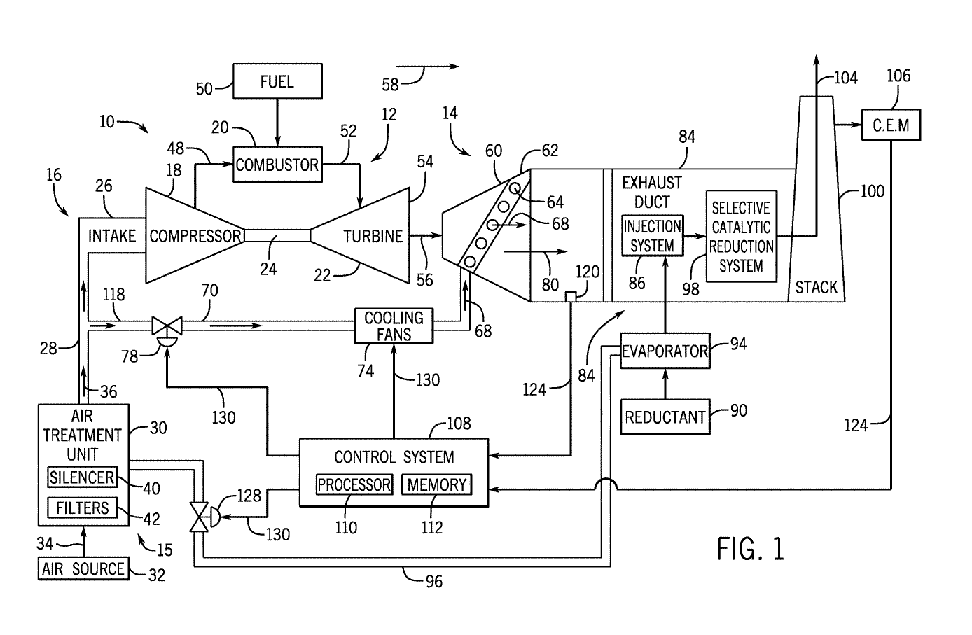

With the foregoing in mind, FIG. 1 is a schematic diagram of an example turbine system 10 that includes a gas turbine engine 12 and an exhaust processing system 14. In certain embodiments, the gas turbine system 10 may be all or part of a power generation system. The gas turbine system 10 may use liquid and/or gas fuel, such as natural gas and/or a hydrogen-rich synthetic gas, to run the gas turbine system 10.

As shown, the gas turbine engine 12 includes an air delivery system 15 having an air intake section 16, a compressor 18, a combustor section 20, and a turbine 22. The turbine 22 may be drivingly coupled to the compressor 18 via a shaft 24. The air intake section 16 includes a plenum chamber 26 adjacent to the compressor 18 and a main air duct 28 (e.g., a vertical air duct) extending between the plenum chamber 26 and an air treatment unit 30. In operation, air enters the turbine engine 12 through the plenum chamber 26 of the air intake section 16 and is pressurized in the compressor 18. The air may be provided by one or more air sources 32 (e.g., including but not limited to ambient air). For example, air 34 from the one or more air sources 32 may flow into air treatment unit 30 of the air delivery system 15 where the air 34 is treated to remove contaminants, thereby generating treated air 36. The treated air 36 flows through the main air duct 28 and into the compressor 18 via the plenum chamber 26.

The air treatment unit 30 includes one or more features that may be used to condition the air 34 and generate the treated air 36. For example, as illustrated in FIG. 1, the air treatment unit 30 includes one or more silencers 40 that may be used to mitigate noise resulting from a flow of the air 34 into and through the air delivery system 15. The silencers may attenuate air borne noise from the compressor 18 through the main air duct and the turbine exhaust noise from auxiliary duct. Due, in part, to the large volume of the air 34, 36 that may be used in the gas turbine system 10, the flow of the air 34, 36 through the air delivery system 15 may be noisy. The one or more silencers 40 may decrease a noise level of the air flow through the air delivery system 15 compared to systems that do not include the one or more silencers 40. In addition to the one or more silencers 40, the air treatment unit 30 includes one or more filters 42. As discussed above, the air 34 may include contaminants that may be removed before use of the air 34 in the gas turbine system 10. The one or more filters 42 may remove the contaminants (e.g., particulates) from the air 34 (e.g., based on size and/or material composition) to increase purity of the air 34, thereby producing the treated air 36.

As discussed above, the air delivery system 15 may distribute the treated air 36 to multiple sections of the gas turbine system 10. For example, in the illustrated embodiment, the treated air 36 may flow through the air intake section 16, which directs the treated air 36 to the compressor 18 where the treated air 36 is pressurized. The compressor 18 may include a plurality of compressor stages coupled to the shaft 24. Each stage of the compressor 18 includes a wheel with a plurality of compressor blades. The rotation of the shaft 24 causes rotation of the compressor blades, which draws the treated air 36 into the compressor 18 and compresses the treated air 36 to produce compressed air 48 prior to entry into the combustor section 20.

The combustor section 20 may include one or more combustors. In one embodiment, a plurality of combustors may be disposed at multiple circumferential positions in a generally circular or annular configuration about the shaft 24. As the compressed air 48 exits the compressor 18 and enters the combustor section 20, the compressed air 48 may be mixed with fuel 50 for combustion within the combustor 20. For example, the combustor 20 may include one or more fuel nozzles that may inject a fuel-air mixture into the combustor 20 in a suitable ratio for desired combustion, emissions, fuel consumption, power output, and so forth. The combustion of the air 48 and fuel 50 may generate hot pressurized exhaust gases 52 (e.g., combustion gases), which may then be utilized to drive one or more turbine blades within the turbine 22. In operation, the combustion gases flowing into and through the turbine 22 flow against and between the turbine blades, thereby driving the turbine blades and, thus, the shaft 24 into rotation to drive a load, such as an electrical generator in a power plant. As discussed above, the rotation of the shaft 24 also causes blades within the compressor 18 to draw in and pressurize the air received by the intake section 16.

The combustion gases that flow through the turbine 22 may exit a downstream end 54 of the turbine 22 as a stream of exhaust gas 56. The exhaust gas stream 56 may continue to flow in a downstream direction 58 toward the exhaust processing system 14. For instance, the downstream end 54 of the turbine 22 may be fluidly coupled to the exhaust processing system 14 and, in the illustrated embodiment, to a transition duct 60.

As discussed above, as a result of the combustion process, the exhaust gas stream 56 may include certain byproducts, such as nitrogen oxides (NOₓ), sulfur oxides (SOₓ), carbon oxides (COₓ), and unburned hydrocarbons. The exhaust processing system 14 may be employed to reduce or substantially minimize the concentration of such byproducts before the exhaust gas stream exits the system 10. As mentioned above, one technique for removing or reducing the amount of NOₓ in an exhaust gas stream is by using a Selective Catalytic Reduction (SCR) process. For example, in an SCR process for removing NOₓ from the exhaust gas stream 56, ammonia (NH₃) is injected into the exhaust gas stream and reacts with the NOₓ in the presence of a catalyst to produce nitrogen (N₂) and water (H₂O).

The effectiveness of this SCR process may be at least partially dependent upon the temperature of the exhaust gas that is processed. For instance, the SCR process for removing NOₓ may be particularly effective at temperatures of approximately 500 to 900 degrees Fahrenheit (° F.) (e.g., approximately 260 to 482 degrees Celsius (° C.)). In certain embodiments, however, the exhaust gas stream 56 exiting the turbine 22 and entering the transition duct 60 may have a temperature of approximately 1000 to 1500° F. or, more specifically, 1100 to 1200° F. Accordingly, to increase the effectiveness of the SCR process for NOₓ removal, the exhaust processing system 14 may include a transition air injection system 62 configured to inject cooling air into the exhaust gas stream 56, thereby cooling the exhaust gas stream 56 prior to SCR. It should be understood that the effective temperatures may vary depending on the element being removed from the gas stream 56 and/or the catalyst being employed.

As shown in FIG. 1, the transition air injection system 62 may be disposed within the transition duct 60. The transition air injection system 62 may include a plurality of air injection tubes 64 (or other outlets) having a plurality of air injection holes configured to inject cooling air 68 provided by the air delivery system 15 into the transition duct 60 for mixture with the exhaust gas stream 56. For instance, an auxiliary air duct (e.g., a cooling air duct 70) may receive cooling air from the air intake section 16 and direct the cooling air 68 into the transition air injection system 62. As discussed above, the main air duct 28 of the air intake section 16 receives treated air 36 from the air treatment unit 30. The cooling air duct 70 may be fluidly coupled to the main air duct 28 such that the cooling air duct 70 may receive at least a portion of the treated air 36 flowing through the main air duct 28. For example, the cooling air duct 70 may extend from a vertical portion of the main air duct 28 to provide better mixing of cold ambient air and hot gas turbine exhaust flue gas, therefore more uniform temperature. Positioning the cooling air duct 70 along the vertical portion of the main air duct 28 may facilitate a flow of the treated air 36 into the cooling air duct 70. The cooling air duct 70 may direct the portion of the treated air 36 to the transition air injection system 62. Accordingly, an air treatment unit may be omitted from the cooling air duct 70. In this way, a configuration of the gas turbine system 10 may be simplified compared to gas turbine systems that include air treatment units dedicated to each air duct and/or section of the gas turbine system 10. Because the air treatment unit 32 treats the air 34 provided to various system components of the gas turbine system 10, the air treatment unit 32 may be sized to allow sufficient air to be treated and distributed to various system components of the gas turbine system 10.

As will be appreciated, the term “cooling,” when used to describe the air flow, should be understood to mean that the air 68 is cooler relative to the exhaust gas stream 56 exiting the turbine 22. The cooling air 68 supplied by the air delivery system 15 may be ambient air, or may be further cooled using a heat exchanger or other type of suitable cooling mechanism. For example, in certain embodiments, one or more cooling fans 74 disposed along the cooling air duct 70 may cool the treated air 36 to a temperature below ambient to generate the cooling air 68.

The cooling air duct 70 may also include one or more valves for regulating the flow of treated air 36 and/or the cooling air 68 into and out of the cooling air duct 70. For example, as illustrated, the cooling air duct 70 includes a flow control device (e.g., a valve 78 or a baffle) upstream of the cooling fans 74 and adjacent to the main air duct 28. As discussed in further detail below, the valve 78 may adjust a flow of the treated air 36 such that a desirable amount of the treated air 36 flows through the cooling air duct 70 and into the transition air injection system 62 to provide sufficient cooling of the exhaust gas stream 56. By way of example, in one embodiment, the exhaust gas stream 56 output from the turbine 22 may flow into the transition duct 60 at a rate of approximately 1000 to 1500 pounds/second (e.g., approximately 450 to 680 kilograms/second), and the cooling air 68 may be injected into the transition duct 60 (via the transition air injection system 62) at a rate of approximately 300 to 750 pounds/second (e.g., approximately 136 to 340 kilograms/second). Accordingly, the valve 78 may adjust a flow rate of the portion of the treated air flowing into the transition air injection system 62 such that the desired flow rate may be achieved. It should be understood, however, that the flow rate of the exhaust gas stream 56 and the flow rate of the cooling air 68 may vary according to various control procedures, which are described in further detail below.

While in the transition duct 60, the cooling air 68 mixes with the exhaust gas stream 56 to produce a cooled exhaust gas stream 80. As discussed above, the cooled exhaust gas 80 may have a temperature of approximately 500 to 900° F., e.g., a temperature suitable for increasing or substantially maximizing NOₓ removal in the SCR process. The exhaust processing system 14 may include one or more mixing systems along the flow path of the exhaust gas stream configured to facilitate mixing of the exhaust gas stream 56 and the cooling air 68 to achieve a uniform temperature distribution in the cooled exhaust gas 80 prior to downstream SCR processing.

To further prepare the exhaust gas 56 for the SCR process, the cooled exhaust gas stream 80 may continue flowing downstream (e.g., in direction 58) into an exhaust duct 84. In a portion of the exhaust duct 34, the exhaust gas stream 80 may flow through an injection system 86 configured to inject a reductant 90 (e.g., ammonia (NH₃)) into the cooled exhaust gas stream 80.

The reductant 90 may be vaporized in evaporator 94 before flowing into the injection system 86. In certain embodiments, the evaporator 94 may use heated air to vaporize the reductant 90. In one embodiment, as shown, the gas turbine system 10 may include an evaporator air duct 96 fluidly coupled to the air delivery system 15. For example, in certain embodiments, the evaporator air duct 96 may extend between the air treatment unit 30 and the evaporator 94. The evaporator air duct 96 may direct at least a portion of the treated air 36 to the evaporator 94 for vaporization of the reductant 90. The evaporator air duct 96 may include one or more heat exchangers that may heat the treated air 36 to a temperature suitable for vaporizing the reductant 90. In certain embodiments, the evaporator air duct 96 may be fluidly coupled to the main air duct 28 and/or the cooling air duct 70 such that the evaporator air duct 96 receives the treated air 36 from either the main air duct 28 or the cooling air duct 70.

Downstream of the injection system 86, an SCR system 98 may include a supported catalyst system having any suitable geometry, such as a honeycomb or plate configuration. Within the SCR system 98, the reductant 90 reacts with the NOₓ in the cooled exhaust gas 80 to produce nitrogen (N₂) and water (H₂O), thus removing NOₓ from the cooled exhaust gas 80 prior to exiting the gas turbine system 10 through a stack 100, as indicated by arrow 104. The stack 100, in some embodiments, may include a silencer or muffler similar to the silencer 40. By way of non-limiting example, the exhaust processing system 14 may utilize the main air duct 28 to direct at least a portion of the treated air 36 to the cooling air duct 70 that supplies the transition air injection system 62 with the cooling air 68. The transition air injection system 62 may inject the cooling air 68 into the exhaust gas stream 56 to generate the cooled exhaust gas 80 having a temperature suitable for reducing the composition of NOₓ in the cooled exhaust gas stream 80, to approximately 3 ppm or less, within the SCR system 98. In certain embodiments, atomized water may be mixed with the cooling air 68, and the water-air mixture may be injected into the transition duct 60 to lower exhaust gas temperature.

While certain embodiments of the present disclosure are generally directed to the processing and removal of NOₓ from the exhaust gas stream 56, the removal of other combustion byproducts, such as carbon monoxide and/or unburned hydrocarbons may also be facilitated in accordance with aspects of the present disclosure. Additionally, it should be understood that the embodiments disclosed herein are not limited to the use of one SCR system 98, but may also include multiple SCR systems 98. Still further, the system 10 may also include a continuous emissions monitoring (CEM) system 106 that continuously monitors the composition of the treated exhaust gas 104 exiting the stack 100. The CEM system 106 may include one or more processors, memory, instruction sensors, etc. that may facilitate monitoring the composition of the treated exhaust gas 104. In response to determining that the composition of treated exhaust gas 104 is not within a predetermined set of parameters, the CEM system 106 may a provide notification to a control system 108 of the gas turbine system 10. The control system 108 may in turn take certain corrective actions to adjust combustion parameters, adjust flows of the treated air 36 and/or the cooling air 68, adjust operation of the SCR system 98, and so forth.

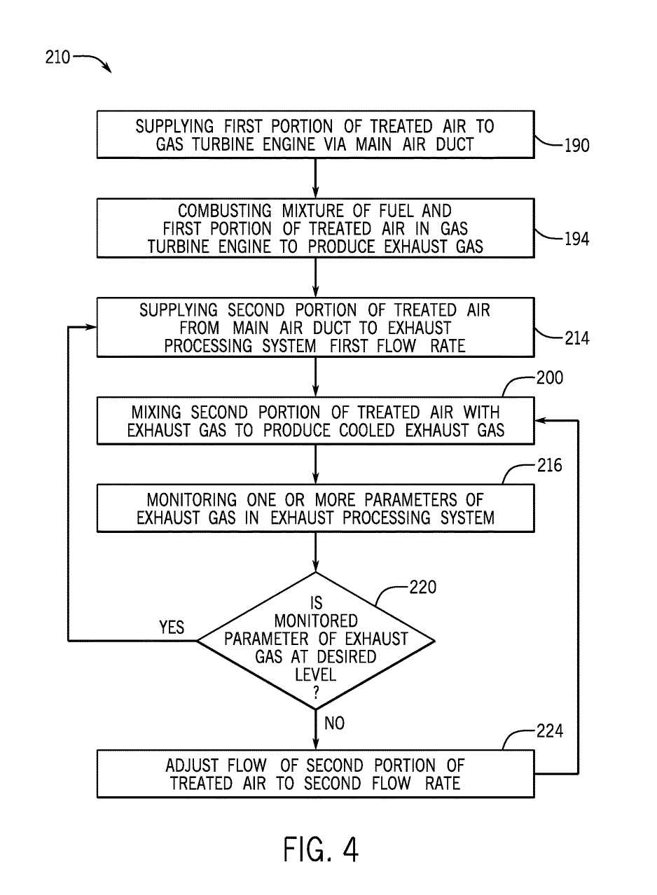

For example, the control system 108 may adjust a flow of the cooling air 68 into the transition air injection system 62 by electronically communicating with sensors, control valves (e.g., valve 78), fans, and pumps, or other flow adjusting features throughout the gas turbine system 10. The control system 108 may be implemented as a distributed control system (DCS) or any computer-based workstation that is fully or partially automated. For example, the control system 108 can be any device employing one or more general purpose or application-specific processors 110 (e.g., micro-processor), which may generally be associated with memory circuitry 112 for storing instructions such as exhaust processing parameters. The processors 110 may include one or more processing devices, and the memory circuitry 112 may include one or more tangible, non-transitory, machine-readable media collectively storing instructions executable by the processors 110 to perform the acts of FIGS. 4 and 5, as discussed below, and control actions described herein.

In one embodiment, the control system 108 may operate flow control devices (e.g., valves, pumps, etc.) to control amounts and/or flows between the different system components. In the illustrated embodiment, the control system 108 is communicatively coupled to and controls the valve 78 to enable automatic adjustment of the flow of the treated air 36 into the cooling air duct 70. For example, during start-up of the gas turbine system 10, the control system 108 may provide instructions to close the valve 78 and block a flow of the treated air 36 into the cooling air duct 70. In this situation, the treated air 36 exiting the air treatment unit 30 primarily flows through the main air duct 28 and into the compressor 18 of the gas turbine engine 12. Following startup of the gas turbine system 10 and production of the exhaust gas 52, the control system 108 may provide instructions to open the valve 78 and allow at least a portion of the treated air 36 to flow into the cooling air duct 70, as shown by arrow 118. Accordingly, the cooling air duct 70 may direct at least a portion of the treated air 36 to the air injection system 86 for cooling the exhaust gas stream 56 in the transition section 60. In certain embodiments, the cooling air duct 70 may include a fan or a booster (e.g., a pump) to facilitate drawing the portion 118 of the treated air 36 into the cooling air duct 70.

The control system 108 may also control the cooling fans 74 to adjust a temperature and/or flow rate of the treated air 36 in the cooling air duct 70. For example, the control system 108 may provide instructions to activate the cooling fans 74 and enable cooling of the treated air 36 to a temperature level (e.g., a temperature below ambient temperature) suitable for cooling the exhaust gas stream 56 to a desired temperature for the SCR process. In other embodiments, the control system 108 may provide instructions to deactivate the cooling fans 74 such that the cooling air 68 entering the transition air injection system 62 is at ambient temperature (e.g., within approximately 5% and 10% of ambient). One or more temperature sensors 120 may be disposed at one or more locations within the exhaust processing system 14. The one or more temperature sensors 120 may monitor a temperature of the cooled exhaust gas 68 upstream of the injection system 86 and transmit an input signal 124 to the control system 108 indicative of the temperature of the cooled exhaust gas 80. The control system 108 may adjust the valve 78 and/or the cooling fans 74 based on the temperature of the cooled exhaust gas 80. For example, if a temperature of the cooled exhaust gas 80 is above a desired temperature level, the control system 108 may provide instructions to the valve 78 to increase a flow of the portion 118 of the treated air 36. In other embodiments, the control system 108 may provide instructions to the cooling fans 74 to increase or decrease a rotational speed of the fan based on the temperature of the cooled exhaust gas 80.

It should be noted that there may be additional valves throughout the gas turbine system 10 used to adjust different amounts and/or flows between the system components. The control system 108 may also provide instructions to a valve 128 disposed on the evaporator air duct 96 to block or allow a flow of the treated air 36 to the evaporator 94.

The control system 108 may use information provided via input signals (e.g., signal 124) to generate one or more output signals 130 for the various flow control devices (e.g., valves 78, 128) to control a flow of the treated air 36 through the ducts 28, 70, 96 within the gas turbine system 10. Additionally or alternatively, the control system 108 of the gas turbine system 10 may perform functions such as notifying the operators of the system 10 to adjust operating parameters, perform service, or otherwise cease operating the system 10 until the treated exhaust gas 104 produced by the system 10 has a composition that is within a predetermined requirement. In some embodiments, the CEM system 106, alone or in conjunction with the control system 108, may also implement corrective actions specifically relating to the exhaust processing system 14 such as adjusting temperature, flow rates of cooling air 68, an amount of NH₃ injected into SCR system 98, etc.

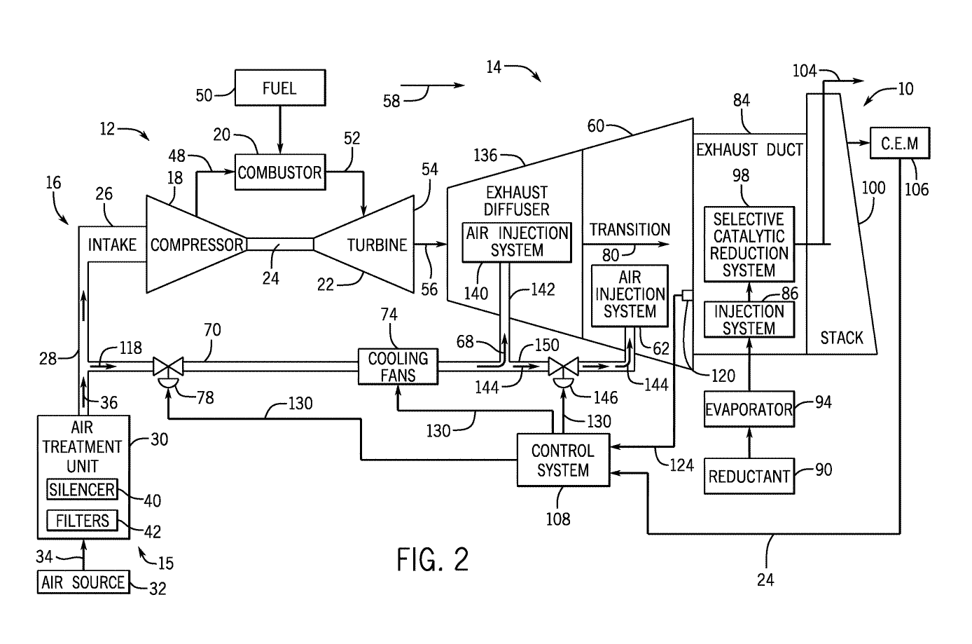

In certain embodiments, the exhaust processing system 14 of the gas turbine system 10 may include additional components that may facilitate cooling the exhaust gas stream 56. For example, as illustrated in FIG. 2, the gas turbine system 10 includes an exhaust diffuser 136 fluidly coupled to the turbine 22 and the transition section 60. The exhaust diffuser 136 may include certain air injection features configured to facilitate mixing of the exhaust gas stream 56 with cooling air (e.g., the cooling air 68). Accordingly, as shown in the illustrated embodiment, the exhaust diffuser 136 includes a diffuser air injection system 140 fluidly coupled to the cooling air duct 70 via a diffuser air duct 142. As discussed above, it is now recognized that the treated air 36 from the main air duct 28 may be distributed to various system components to reduce the number of air treatment units used to treat the air 34 compared to systems that have air treatment unit dedicated to each air duct (e.g., intake section air duct, cooling air duct, evaporator air duct, etc.). Therefore, by coupling the diffuser air injection system 140 to the cooling air duct 70, an air treatment unit dedicated to the diffuser 136 may be omitted from the diffuser air duct 142, and the configuration of the gas turbine system 10 may be simplified.

The diffuser air injection system 140 may receive the cooling air 68 from the cooling air duct 70 and inject the cooling air 68 into the exhaust diffuser 136 upstream of the transition section 60. The cooling air 68 may mix with the exhaust gas stream 56 to cool the exhaust gas stream 56 and generate the cooled exhaust gas stream 80 in the exhaust diffuser 136. Injecting the cooling air 68 into the exhaust diffuser 136 may increase a residence time of the cooling air 68 and the exhaust gas stream 56 within the exhaust processing system 14 compared to exhaust processing systems that do not include the exhaust diffuser 136. As such, the cooling air 68 and the exhaust gas stream 56 may have more time to mix, and the resultant cooled exhaust gas 80 may have a uniform temperature distribution.

The cooling air duct 70 may also supply additional cooling air 68 downstream of the exhaust diffuser 136. For example, in the illustrated embodiment, the cooling air duct 70 supplies a portion 144 of the cooling air 68 to the transition section 60. As discussed above, the temperature sensor 120 may monitor the temperature of the cooled exhaust gas 80 as the cooled exhaust gas 80 flows through the exhaust processing system 14. Accordingly, if the temperature of the cooled exhaust gas 80 is above the temperature level suitable for the SCR process, the control system 108 may provide instructions to open a valve 146 disposed on the cooling air duct 70 between the diffuser air duct 142 and the transition section 60. Opening the valve 146 may enable the portion 144 of the cooling air 68 to flow through a section 150 of the cooling air duct 70 and into the transition air injection system 62. The transition air injection system 62 may inject the additional cooling air 68 (e.g., the portion 144) into the transition section 60 to adjust a temperature of the cooled exhaust gas 80. Once the temperature of the cooled exhaust gas 80 is at the desired temperature level, the control system 108 may provide instructions to close the valve 146 and block the flow of the cooling air 68 into the transition section 60. Thus, in accordance with an aspect of the present disclosure, the control system 108 may monitor temperatures of the exhaust gas upstream of the SCR catalyst, and may regulate cooling air flows through the exhaust diffuser 136 and the transition section 60 accordingly.

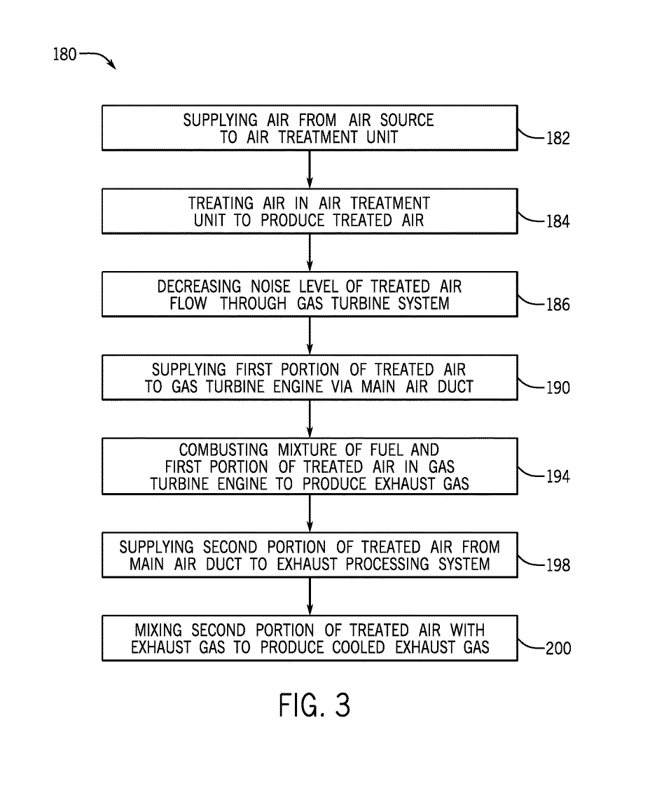

In accordance with various embodiments described above, the configuration of the gas turbine system 10 may be simplified by having the air delivery system 15 distribute the treated air 36 to various system components, thereby decreasing the overall operational and maintenance costs of the gas turbine system 10. FIG. 3 illustrates a flow diagram of a method 180 by which a gas turbine system (e.g., the gas turbine system 10 described above) may use a central air delivery system (e.g., the air delivery system 15) to distribute treated air (e.g., the treated air 36) to an exhaust processing system (e.g., the exhaust processing system 14) in accordance with such embodiments. The method 180 includes supplying the air 34 from the one or more air sources 32 to the air treatment unit 30 of the air delivery system 15 (block 182), and treating the air 34 in the air treatment unit 30 to generate the treated air 36 (block 184), as described above with reference to FIG. 1. For example, the air 34 may be filtered through the filters 42 to remove particulates and other undesirable contaminants from the air 34 to generate the treated air 36.

The method 180 also includes decreasing a noise level of the treated air 36 flow through the gas turbine system 10 (block 186). For example, the air treatment unit 30 includes the silencer 40, which may mitigate noise resulting from the flow of the treated air 36 through the air ducts 28, 70, 96 of the gas turbine system 10.

Once the air treatment unit 30 treats the air 34, the treated air 36 may be distributed to the various system components. Accordingly, the method 180 includes supplying a first portion of the treated air 36 to the gas turbine engine 12 via the main air duct 28 (block 190). For example, the main air duct 28 may direct the first portion of the treated air 36 to the compressor 18 of the gas turbine engine 12 where the first portion of the treated air 36 is pressurized. In accordance with an embodiment, the pressure difference created between the air treatment unit 30 and the compressor intake 16 by such compression may motivate the treated air 36 at least through the main duct 28.

Following compression of the first portion of the treated air 36, the method 180 includes combusting the fuel 50 and the first portion of the treated air 36 in the combustor 20 to generate the exhaust gas stream 56 (block 194). As discussed above, the exhaust gas stream 56 may include combustion byproducts, such as nitrogen oxides (NOₓ), sulfur oxides (SOₓ), carbon oxides (COₓ), and unburned hydrocarbons that may need to be reduced or removed (e.g., to achieve certain emission levels). Therefore, the exhaust gas stream 56 may undergo treatment in the exhaust processing system 14 to remove these byproducts. The exhaust gas treatment process may include reacting the exhaust gas stream 56 with the reductant 90 in the presence of a catalyst in the SCR system 98. The efficiency of the catalyst may be affected by the elevated temperatures of the exhaust gas stream 56 exiting the turbine 22. Therefore, the exhaust gas stream 56 may be cooled before undergoing treatment in the SCR system 98.

Accordingly, the method 180 also includes supplying a second portion (e.g., the portion 118) of the treated air 36 from the main air duct 26 to the exhaust processing system 14 via the cooling air duct 70 (block 198) and mixing the second portion of the treated air 36 with the exhaust gas stream 56 to cool the exhaust gas stream 56 and generate the cooled exhaust gas 80 (block 200). In accordance with certain aspects of the present disclosure, the acts of blocks 190 and 198 may occur at substantially the same time. That is, the first and second portions of the treated air 36 may be supplied to the gas turbine engine 12 and the cooling air duct 70, respectively, simultaneously. By using the treated air 36 from the main air duct 28 to cool the exhaust gas stream 56 in the exhaust processing system 14, the cooling air duct 70 or the exhaust processing system 14 may not include additional air treatment units for treating the cooling air before injecting the cooling air into the exhaust gas stream 56. In this way, the number of air treatment units used by the gas turbine system 10 to treat the air 34 may be decreased. Decreasing the number of air treatment units in the gas turbine system 10 may result in a less complex configuration compared to gas turbine system that include air treatment units dedicated to each air duct and/or section of the gas turbine system. Consequently, the overall operational and maintenance costs of the gas turbine system 10 may be decreased.

During start-up of the gas turbine system 10, the gas turbine engine 12 may not immediately generate exhaust gas, or the exhaust gas that is generated may not necessarily need to be treated in the exhaust gas processing system 14. Accordingly, during start-up, the main air duct 28 may not supply the second portion of the treated air 36 to the cooling air duct 70. Rather, the second portion of the treated air 36 may continue to flow through the main air duct 28 and into the compressor 18 of the gas turbine engine 12. As such, a flow control device (e.g., the valve 78) may be positioned to block or restrict the second portion of the treated air 36 from flowing into the cooling air duct 70. After steady-state operation of the gas turbine engine 12 is reached, the control system 108 may provide instructions to open the valve 78 such that the second portion of the treated air 36 may flow through the cooling air duct 70 and into the exhaust processing system 14. In this way, the second portion of the treated air 36 may be used to cool the exhaust gas stream 56 as discussed above with reference to FIGS. 1 and 2, and air treatment units may be omitted from the cooling air duct 70 and/or the exhaust processing system 14.

To this end, the control system 108 may account for a number of factors in controlling the relative amount of the treated air 36 through the cooling air duct 70 versus the flow to the compressor. Thus, present embodiments also include a method for controlling a flow rate of the portion 118 of the treated air 36 through the cooling air duct 70. For example, FIG. 4 is a flow diagram of a method 210 that may be used to adjust a flow rate of the portion 118 of the treated air 36 based on a temperature of the cooled exhaust gas 80 in the exhaust processing system 14, based on an estimated or modeled efficiency of the SCR system 98, and so forth. The method 210 includes supplying the first portion of the treated air 36 to the compressor 18 of the gas turbine engine 12 via the main air duct (block 190) and combusting the mixture of the fuel 50 and the first portion of the treated air 36 in the gas turbine engine 12 to produce the exhaust gas stream 56 (block 194), as discussed above with reference to FIGS. 1-3.

The method 210 also includes supplying the second portion (e.g., the portion 118) of the treated air 36 from the main air duct 28 to the exhaust processing system 14 at a first flow rate (block 214). For example, during operation of the gas turbine system 10, the control system 108 may receive the input signals 124 from C.E.M. 106 and/or the one or more temperature sensors 120. The input signals 124 may provide information associated various properties of the cooled exhaust gas 80. For example, the input signals 124 may provide information associated with the temperature and/or composition of the cooled exhaust gas 80. As discussed above, the cooled exhaust gas 80 may be treated in the SCR system 98 to remove combustion byproduct such as NOₓ, SOₓ, and COₓ among others before the cooled exhaust gas 80 is released from the gas turbine system 10. The C.E.M. 106 may provide the control system 108 with information about concentration levels of the combustion byproducts in the treated exhaust gas 104. If the concentration level of one or more of the combustion byproducts in the treated exhaust gas 104 is above a desired concentration level, the control system 108 may adjust one or more system components such that the combustion byproducts in the treated exhaust gas 104 are at or below the desired concentration level.

As discussed above, the effectiveness of the SCR system 98 for removing the combustion byproducts may be affected by the temperature of the exhaust gas stream 56, 80. For example, if a temperature of the cooled exhaust gas 80 is above a temperature level suitable for SCR processing, the SCR system 98 may be unable to effectively remove the combustion byproducts from the cooled exhaust gas 80. Accordingly, the method 210 includes monitoring one or more parameters of the exhaust gas (e.g., the cooled exhaust gas 80 and/or the treated exhaust gas 104) flowing through the exhaust processing system 14 (block 216). For example, in certain embodiments, the temperature of the cooled exhaust gas 80 may be monitored using the one or more temperature sensors 120 in the exhaust processing system 14. The one or more temperature sensors 120 may transmit the input signal 124 to the control system 108. The input signal 124 may be indicative of the temperature of the cooled exhaust gas 80 within the exhaust processing system 14. In other embodiments, the composition of the treated exhaust gas 104 may be monitored, as discussed above according to the acts of block 214.

The control system 108 may determine (e.g., based on one or more of the input signals 124) whether the monitored parameter of the exhaust gas (e.g., the cooled exhaust gas 80 and/or the treated exhaust gas 104) is at desired level (query 220). In embodiments where the temperature level of the cooled exhaust gas 80 is not at a temperature level suitable for the SCR process, the method 210 may adjust a flow rate of the second portion of the treated air 36 to a second flow rate that is different than (e.g., higher than) the first flow rate (block 224). For example, the control system 108 may adjust an amount of the second portion of the treated air 36 (e.g., the portion 118), that flows from the main air duct 28 and into the cooling air duct 70. Similarly, if the concentration levels of the combustion byproducts in the treated exhaust gas 104 are above a desired level, the control system 108 may adjust the amount of the second portion of the treated air 36 such to further cool the cooled exhaust gas 80. In making these adjustments, the control system 108 may control appropriate flow control devices (e.g., the valves 78, 146) to adjust the amount of the cooling air 68 that flows into the exhaust processing system 14 to cool the exhaust gas stream 56.

In certain embodiments, the control system 108 may adjust cooling parameters of the cooling fans 74 (e.g., a speed of the cooling fans 74) such that the cooling fans 74 decrease a temperature of the cooling air 68 to a temperature suitable for cooling the exhaust gas stream 56 to the desired temperature level for SCR processing. It should be noted that one or a combination of these adjustments may be made, and any and all permutations of combinations are presently contemplated. In embodiments where the temperature of the cooled exhaust gas stream 80 is at the temperature level suitable for SCR processing, the method 210 continues to supply the second portion of the treated air 36 from the main air duct 28 to the cooling air duct 70 at the first flow rate (block 214).

As discussed above, the various techniques set forth herein may have a number of technical effects, and may simplify the configuration of the gas turbine system 10 by reducing the number of air treatment units used for treating the air 34. For instance, the techniques disclosed include fluidly coupling one or more air ducts (e.g., cooling air duct 70, evaporator air duct 96, etc.) to a main air duct (e.g., the main air duct 28 of the intake section 16) of an air delivery system. The main air duct may be equipped with an air treatment unit that may treat air from one or more air sources to remove contaminants from the air and reduce noise levels, thereby generating treated air. The main air duct may distribute the treated air to various system components through one or more auxiliary air ducts (e.g., the cooling air duct 70, the evaporator air duct 96, etc.). As such, the overall operational and maintenance costs associated with the gas turbine system may be reduced due, in part, to a reduced amount of air treatment units used to treat the air from the one or more air source before use of the air in the gas turbine system. It should be understood that the disclosed techniques and configurations of the auxiliary air ducts (e.g., the cooling air duct 70 and the evaporator air duct 96) are intended to be examples of certain embodiments.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A gas turbine system, comprising:
a gas turbine engine;
an exhaust processing system disposed downstream of and fluidly coupled to the gas turbine engine; and
an air delivery system configured to supply treated air to the gas turbine engine and the exhaust processing system, wherein the air delivery system comprises a main air duct fluidly coupled to the gas turbine engine and configured to supply a first portion of the treated air to the gas turbine engine, an auxiliary air duct fluidly coupled to the main air duct and the exhaust processing system and configured to supply a second portion of the treated air to the exhaust processing system, and an air treatment unit fluidly coupled to the main air duct and configured to generate the treated air.

2. The system of claim 1, wherein the auxiliary air duct extends from a vertical portion of the main air duct and comprises a flow control device, wherein the flow control device is configured to adjust the amount of the second portion of the treated air through the auxiliary air duct relative to the amount of the first portion of the treated air provided to the gas turbine engine.

3. The system of claim 1, comprising a control system comprising memory circuitry storing one or more sets of instructions executable by one or more processors of the control system to control one or more valves to adjust an amount of the second portion of the treated air supplied to the auxiliary air duct based on a parameter of an exhaust stream in the exhaust processing system.

4. The system of claim 1, wherein the auxiliary air duct extends between the main air duct and a section disposed in the exhaust processing system and is configured to supply the treated air to an air injection system disposed within the section, wherein the section is positioned upstream of a selective catalyst reduction catalyst of the exhaust processing system.

5. The system of claim 1, wherein the auxiliary air duct extends between the main air duct and an evaporator fluidly coupled to the exhaust processing system of the gas turbine system and is configured to supply the treated air to the evaporator.

6. The system of claim 1, wherein the auxiliary air duct extends between the main air duct and an exhaust diffuser disposed in the exhaust processing system and is configured to supply the treated air to an air injection system disposed within the exhaust diffuser.

7. The system of claim 1, wherein at least a portion of the air delivery system is disposed within an intake section of the gas turbine engine.

8. The system of claim 1, wherein the air treatment unit comprises a filter configured to remove contaminants from ambient air to generate the treated air.

9. The system of claim 1, wherein the air treatment unit comprises a silencer configured to decrease a noise level from a gas turbine compressor, the main air duct, the auxiliary air duct, gas turbine exhaust through the exhaust processing system, or a combination thereof.

10. The system of claim 1, comprising one or more cooling fans disposed within the auxiliary air duct, wherein the one or more cooling fans are configured to decrease a temperature of the treated air upstream of the exhaust processing system.

11. A gas turbine system, comprising:
an air delivery system comprising an air treatment unit configured to treat an air stream to generate treated air, a main air duct extending between the air treatment unit and a gas turbine engine and configured to receive the treated air from the air treatment unit and to supply a first portion of the treated air to the gas turbine engine, and an auxiliary air duct fluidly coupled to the main air duct and configured to receive a second portion of the treated air from the main air duct and to supply the second portion of the treated air to an exhaust processing system disposed downstream of the gas turbine engine; and
a control system having memory circuitry storing one or more sets of instructions executable by one or more processors of the control system to control an amount of the second portion of the treated air through the auxiliary air duct based on a monitored parameter of an exhaust gas in the exhaust processing system.

12. The system of claim 11, comprising a flow control device disposed on the auxiliary air duct, wherein the flow control device is configured to adjust the amount of the second portion of the treated air through the auxiliary air duct relative to the amount of the first portion of the treated exhaust gas provided to the gas turbine engine.

13. The system of claim 11, wherein the auxiliary air duct comprises one or more cooling fans configured to cool the second portion of the treated air.

14. The system of claim 11, comprising an air injection system disposed within a transition section or an exhaust diffuser of the exhaust processing system, wherein the auxiliary air duct is configured to supply the second portion of the treated air to the air injection system to initiate heat exchange between the exhaust gas and the treated air in the transition section or the exhaust diffuser.

15. The system of claim 11, wherein the air treatment unit comprises one or more filters configured to remove contaminants from the air stream to generate the treated air.

16. The system of claim 11, wherein the air treatment unit comprises a silencer configured to decrease a noise level from a gas turbine compressor, the main air duct, the auxiliary air duct, gas turbine exhaust through the exhaust processing system, or a combination thereof.

17. A method, comprising:
flowing an air stream through an air delivery system of a gas turbine system, wherein at least a portion of the air delivery system is disposed within an intake section of a gas turbine engine and comprises a main air duct, an auxiliary air duct extending from the main air duct, and an air treatment unit disposed upstream of the main air duct;
filtering the air stream in the air treatment unit to generate treated air;
supplying a first portion of the treated air to a compressor of a gas turbine engine of the gas turbine system via the main air duct; and
supplying a second portion of the treated air from the main air duct to the auxiliary air duct, wherein the auxiliary air duct is fluidly coupled to an exhaust processing system of the gas turbine system disposed downstream of the gas turbine engine.

18. The method of claim 17, comprising cooling the second portion of the treated air in the auxiliary air duct using one or more cooling fans disposed within the auxiliary air duct to generate cooling air.

19. The method of claim 18, comprising injecting the cooling air from the auxiliary air duct into the exhaust processing system to decrease a temperature of an exhaust gas stream generated by the gas turbine engine.

20. The method of claim 19, comprising controlling a flow rate of the second portion of the treated air supplied to the auxiliary air duct based at least on the temperature of the exhaust gas stream.
